(19) United States
(12) Patent Application Publication
(10) Pub. No.: US 2004/0002302 A1
(43) Pub. Date: Jan. 1, 2004

(54) Image data transmission method, portable terminal apparatus, image processing method, image processing apparatus, and computer program therefor

(75) Inventors: Fumito Takemoto, Kanagawa-ken (JP); Tatsuya Aoyama, Kanagawa-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/465,668

(22) Filed: Jun. 20, 2003

(30) Foreign Application Priority Data
Jun. 26, 2002 (JP) 185869/2002
Sep. 26, 2002 (JP) 281504/2002

(51) Int. Cl. H04H 1/00; H04H 7/00

(52) U.S. Cl. 455/3.06; 455/3.05

(57) ABSTRACT

Image processes that reflect the intentions of a photographer are administered on image data obtained by a portable terminal apparatus such as a cellular telephone with built in camera. Image processes are administered on image data obtained by the cellular telephone with built in camera by an image processing means to obtain processed image data. The processed image data is displayed on an LCD monitor, and corrections that further reflect the user's intentions are performed by an image correcting means according to user commands from an input means to obtain corrected processed image data. The corrected processed image data and the image data are displayed on the LCD monitor in a divided display manner.

### BACKGROUND OF THE INVENTION

1. Field of the Invention

The present invention relates to a portable terminal apparatus such as a cellular telephone with a built in camera that obtains image data by photography and transmits the image data to an image server, an image data transmission method for use by the portable terminal apparatus, and a program that causes a computer to execute the image data transmission method.

The present invention also relates to a method and apparatus for image processing that administers image processes on image data to obtain processed image data, and a program that causes a computer to execute the image processing method.

2. Description of the Related Art

Cellular telephones are rapidly becoming widespread. In recent years, cellular telephones with built in cameras as imaging means for obtaining image data by photography (as disclosed in, e.g., Japanese Unexamined Patent Publication Nos. 6(1994)-233020, 9(1997)-322114 and 2000-252290 and U.S. Laid-Open No. 20020032909 and U.S. Pat. No. 6,337,712) are also spreading. By using such cellular telephones with built in cameras, favored image data obtained by photography may be set as the wallpaper for the cellular phone's display. In addition, image data obtained by photography can be attached to e-mail messages and sent to friends. Therefore, in case an appointment must be cancelled, or if one is running late for an appointment, an image of one's face showing a sorrowful expression may be sent to a friend, thereby informing them of one's current situation. In this manner, cellular telephones with built in cameras are useful in communicating with friends.

In addition, the functionality of cellular telephones with built in cameras has been improving. It is now possible to obtain image data of a sufficient size to perform printing using cellular telephones with built in cameras.

Meanwhile, image data having been obtained by cellular telephones with built in cameras are being utilized in manners such as: administering various image processes thereon to obtain processed image data; printing; and being uploaded to networks. In this manner, users are capable of obtaining images of high image quality, obtaining prints, and accessing images on networks. Therefore, the manners of use for image data by communication are becoming diversified.

The image data obtained by cellular telephones with built in cameras is utilized by: transmitting the image data from the cellular telephone with built in camera that obtained the image to an image server for storing and managing image data; image processes being administered on the image data at the image server; generating an e-mail message with a URL representing the storage location of the image data; sending the e-mail message to a terminal apparatus such as a cellular telephone, a PC (personal computer) or a PDA, or to a laboratory for performing printing of the image; then downloading the image data to the cellular telephone, the terminal apparatus, or the laboratory by accessing the URL provided in the e-mail message.

The image processes administered to the image data may be performed by the cellular phone with built in camera that obtained the image data. However, the image processes administered by the cellular telephone with built in camera are performed using image processing parameters which are automatically calculated based on the image data. Therefore, intentions of the photographer, that is, the user, such as to brighten the image abit, to emphasize the color red in the image, cannot be reflected in the image data.

In addition, image processes administered to the image data are performed using image processing parameters which are calculated based on the image data. However, image processing parameters calculated in this manner are those for administering image processes to the image data to obtain processed images of a predetermined image quality. Therefore, preferences of the user who obtained the image data, such as to make skin tones reddish, to harden gradation, and to darken the image, cannot be reflected in the image processes.

### SUMMARY OF THE INVENTION

The present invention has been developed in view of the circumstances described above, and it is an object of the present invention to enable image processes to be administered that reflect the intentions of a user who photographed an image to image data obtained by a portable terminal apparatus such as a cellular telephone with built in camera.

In addition, it is another object of the present invention to enable image processes to be administered that reflect the preferences of a user.

A first image data transmission method according to the present invention is an image data transmission method for use by a portable terminal apparatus comprising:

a photography means for obtaining image data by photography;

a communication means for transmitting and receiving data;

an image processing means for administering image processes on the image data to obtain processed image data; and

a display means for performing display in various modes; the method comprising the steps of:

receiving an input of an image correction command for the processed image data;

administering image correction processes on the processed image data to obtain corrected processed image data; and

transmitting the image data or the corrected processed image data to an image server for storing and managing the image data or the corrected processed image data.

Note that the first image data transmission method according to the present invention may further comprise the steps of:

displaying the image data and the corrected processed image data on the display means in a divided display manner;

receiving a transmission command for either the image data or the corrected processed image data; and

transmitting either the image data or the corrected processed image data, for which the transmission command was received, to the image server.

In addition, the first image data transmission method according to the present invention may further comprise the steps of:

displaying a plurality of corrected processed image data, which has been corrected in a plurality of steps, and the image data on the display means in a divided display manner;

receiving a transmission command for the image data or one of the corrected processed image data; and

transmitting the image data or the one corrected processed image data, for which the transmission command was received, to the image server.

Here, the “divided display manner” may be either display with temporal division, or display within divided portions of a screen.

A second image data transmission method according to the present invention is an image data transmission method for use by a portable terminal apparatus comprising:

a photography means for obtaining image data by photography;

a communication means for transmitting and receiving data;

an image processing means for administering image processes on the image data to obtain processed image data; and

a display means for performing display in various modes; the method comprising the steps of:

receiving an input of an image correction command for the processed image data;

administering image correction processes on the processed image data to obtain corrected processed image data; and

transmitting the image data, along with processing parameters of the image processes and the image correction processes, to an image server for storing and managing the image data.

A first portable terminal apparatus according to the present invention comprises:

a photography means for obtaining image data by photography;

a communication means for transmitting and receiving data;

an image processing means for administering image processes on the image data to obtain processed image data;

a display means for performing display in various modes;

an image correcting means for receiving input of an image correction command for the processed image data and administering image correction processes to obtain corrected processed image data; and

a control means for transmitting the image data or the corrected processed image data to an image server for storing and managing the image data or the corrected processed image data.

Note that in the first portable terminal apparatus according to the present invention, the control means may be a means that:

displays the image data and the corrected processed image data at the display means in a divided display manner;

receives a transmission command for either the image data or the corrected processed image data; and

transmits either the image data or the corrected processed image data, for which the transmission command was received, to the image server.

In addition, in the first portable terminal apparatus according to the present invention, the control means may be a means that:

displays a plurality of corrected processed image data, which has been corrected in a plurality of steps, and the image data on the display means in a divided display manner;

receives a transmission command for the image data or one of the corrected processed image data; and

transmits the image data or the one corrected processed image data, for which the transmission command was received, to the image server.

A second portable terminal apparatus according to the present invention comprises:

a photography means for obtaining image data by photography;

a communication means for transmitting and receiving data;

an image processing means for administering image processes on the image data to obtain processed image data; and

a display means for performing display in various modes; and

a control means for receiving an input of an image correction command for the processed image data;

administering image correction processes on the processed image data to obtain corrected processed image data; and

transmitting the image data, along with processing parameters of the image processes and the image correction processes, to an image server for storing and managing the image data.

Note that the first and second image transmission methods of the present invention may be provided as programs that cause a computer to execute the image transmission methods.

According to the first image transmission method and the first portable terminal apparatus of the present invention, image processes are administered to image data obtained by photography, thereby obtaining processed image data; an input of an image correction command for the processed image data is received; and image correction processes are administered on the processed image data to obtain corrected processed image data. Then, the image data or the corrected processed image data is transmitted to an image server for storing and managing the image data or the corrected processed image data.

Therefore, corrected processed image data that reflects the intentions of the photographer, that is, the user of the portable terminal apparatus, or the image data that reflects the intentions of the user to not perform image processes or image correction processes at the portable terminal apparatus is enabled to be transmitted to the image server.

In addition, a configuration may be adopted wherein the image data and the corrected processed image data are displayed at the display means in a divided display manner; a transmission command is received for either the image data or the corrected processed image data; and either the image data or the corrected processed image data, for which the transmission command was received, is transmitted to the image server. In this case, the image data or the corrected processed image data, which positively reflects the user's intention regarding image processes, can be transmitted to the image server.

In addition, a configuration may be adopted wherein a plurality of corrected processed image data, which has been corrected in a plurality of steps, and the image data are displayed on the display means in a divided display manner; a transmission command is received for the image data or one of the corrected processed image data; and the image data or the one corrected processed image data, for which the transmission command was received, is transmitted to the image server. In this case, the image data or one of the corrected processed image data, which positively reflects the user's intention regarding image processes, can be transmitted to the image server.

According to the second image data transmission method and the second portable terminal apparatus of the present invention, image processes are administered to image data obtained by photography, thereby obtaining processed image data; an input of an image correction command for the processed image data is received; and image correction processes are administered on the processed image data to obtain corrected processed image data. Then, the image data is transmitted to the image server with the processing parameters of the correction processes attached thereto.

Therefore, corrected processed image data that reflects the intentions of the photographer, that is, the user of the portable terminal apparatus can be obtained by the image server or the final transmission destination referring to the processing parameters of the image correction processes.

An image processing method according to the present invention is an image processing method for administering image processes on image data to obtain processed image data, comprising the steps of:

obtaining user data that specifies a user who has requested the image processes;

calculating image processing parameters for the image processes based on the image data;

referring to a database that stores user preferences for each user to read out user preferences corresponding to the user for whom the user data was obtained;

correcting the image processing parameters based on the user preferences to obtain corrected image processing parameters; and

administering the image processes on the image data based on the corrected image processing parameters to obtain the processed image data.

Note that in the image processing method according to the present invention, the user preferences may be obtained by:

having a user correct a reference image, on which the image processing is based; and

analyzing the corrected reference image that reflects the preferences of the user.

An image processing apparatus according to the present invention is an image processing apparatus for administering image processes on image data to obtain processed image data, comprising:

a user data obtainment means for obtaining user data that specifies a user who has requested the image processes;

a parameter calculation means for calculating image processing parameters for the image processes based on the image data;

a parameter correction means for referring to a database that stores user preferences for each user to read out user preferences corresponding to the user for whom the user data was obtained and correcting the image processing parameters based on the user preferences to obtain corrected image processing parameters; and

an image processing means for administering the image processes on the image data based on the corrected image processing parameters to obtain the processed image data.

Note that in the image processing apparatus according to the present invention, the user preferences may be obtained by:

having a user correct a reference image, on which the image processing is based; and

analyzing the corrected reference image that reflects the preferences of the user.

Note that the image processing method according to the present invention may be provided as a program that causes a computer to execute the image processing method.

According to the image processing method and the image processing apparatus of the present invention, user data that specifies the user who requested image processing is obtained; the database that stores user preferences regarding image processes is referred to; and the user preferences corresponding to the user for whom the user data was obtained is read out. Meanwhile, image processing parameters for image processes are calculated based on the image data; then the image processing parameters are corrected based on the read out user preferences to obtain corrected image processing parameters. Image processes are administered on the image data based on the corrected image processing parameters. Therefore, processed image data capable of being reproduced as an image that reflects the preferences of the user who requested image processing can be obtained.

In addition, the user preferences may be obtained simply by having a user correct a reference image, on which the image processing is based; and analyzing the corrected reference image that reflects the preferences of the user.

### BRIEF DESCRIPTION OF THE DRAWINGS

FIG. 1 is a schematic block diagram that illustrates an image processing system equipped with a portable terminal apparatus according to an embodiment of the present invention.

FIG. 2 shows a first mode for displaying an original image and a corrected image.

FIG. 3 shows a second mode for displaying an original image and a corrected image.

FIG. 4 is a schematic block diagram that shows the processes performed by an image processing means and an image correcting means.

FIG. 5 is a flow chart that shows the processes performed by a first cellular telephone with built in camera.

FIG. 6 is a flow chart that shows the processes performed at an image server.

FIG. 7 is a flow chart that shows the processes performed at a laboratory.

FIG. 8 is a flow chart that shows the processes performed by a second cellular telephone with built in camera.

FIG. 9 shows a third mode for displaying an original image and a corrected image.

FIG. 10 shows a fourth mode for displaying an original image and a corrected image.

FIG. 11 is a schematic block diagram that shows the structure of a portable terminal apparatus according to another embodiment of the present invention.

FIG. 12 is a schematic block diagram that shows the structure of an image processing system equipped with an image processing apparatus according to an embodiment of the present invention.

FIG. 13 is a flow chart that shows the processes performed at an image processing system equipped with an image processing apparatus according to an embodiment of the present invention.

### DESCRIPTION OF THE PREFERRED EMBODIMENTS

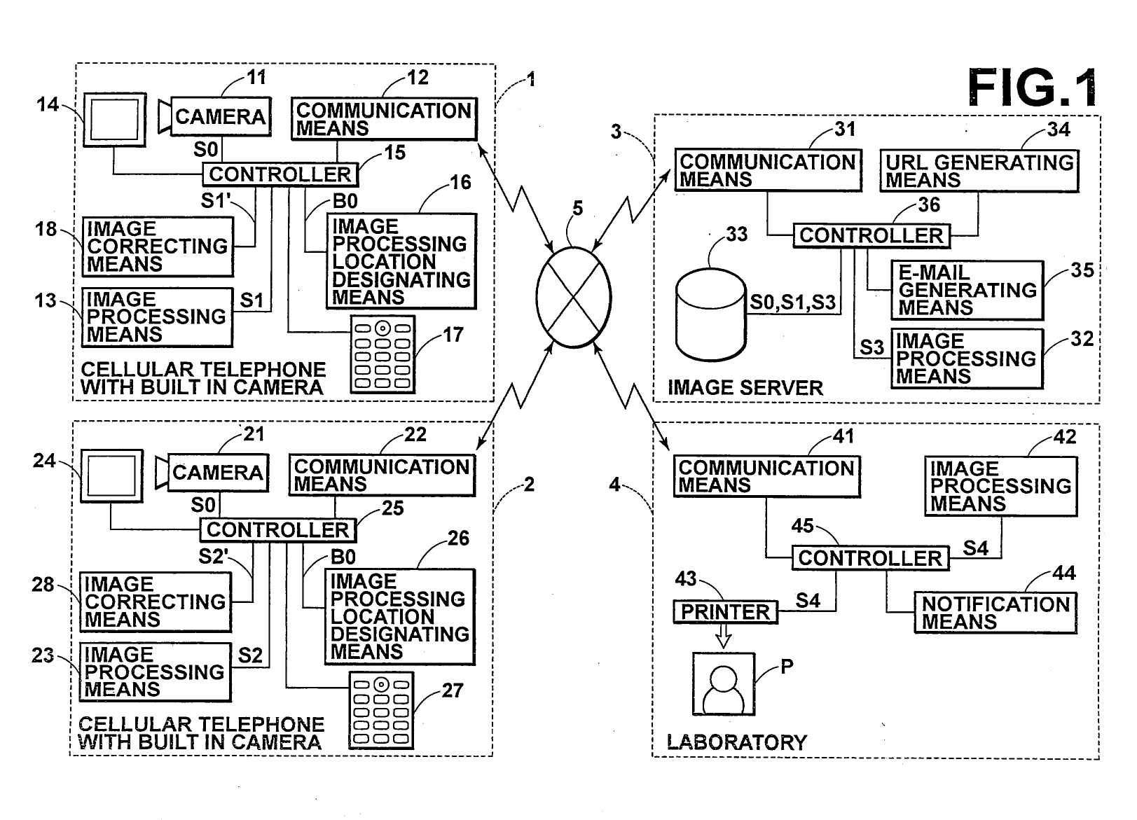

Hereinafter, embodiments of the present invention will be described with reference to the attached drawings. FIG. 1 is a schematic block diagram that illustrates an image processing system equipped with a portable terminal apparatus according to an embodiment of the present invention. As shown in FIG. 1, the image processing system according to the present embodiment comprises: cellular telephones with built in cameras 1 and 2; an image server 3 for storing and managing image data S0 obtained by the cellular telephones with built in cameras 1 and 2; a laboratory 4 for printing the image data S0; and a cellular telephone communication network 5 via which data is exchanged among the constituents of the system.

The cellular telephone with built in camera 1 comprises: a camera 11 for obtaining image data S0 by photography; a communication means 12 for transmitting and receiving various types of data including the image data S0; an image processing means 13 for administering image processes on the image data S0 to obtain processed image data S1; an LCD (Liquid Crystal Display) monitor 14 for performing various types of display including images and telephone numbers; a controller 15 for controlling the operations of the cellular telephone with built in camera 1; an image processing location designating means 16 for designating the location at which image processes are to be administered on the image data S0 based on the intended use of the image data S0 and/or desired image quality thereof, as will be described below, and generating location data B0; an input means 17 comprising a plurality of buttons for performing various types of input, such as photography operations by the camera 11, transmission commands for the image data S0, input of the intended use and/or the desired image quality of the image data S0, the transmission destination of the image data S0 or the processed image data S1, specification of whether printing is to be performed, specification of whether the image data is to be stored in the image server 3, commands for administering image processes on the image data S0, and image correction commands; and an image correcting means 18 for administering image correction processes on the processed image data S1 to obtain corrected processed image data S1′, in response to input from the input means 17 by a user of the cellular telephone with built in camera 1.

The cellular telephone with built in camera 2 comprises: a camera 21 for obtaining image data S0 by photography; a communication means 22 for transmitting and receiving various types of data including the image data S0; an image processing means 23 for administering image processes on the image data S0 to obtain processed image data S2; an LCD (Liquid Crystal Display) monitor 24 for performing various types of display including images and telephone numbers; a controller 25 for controlling the operations of the cellular telephone with built in camera 1; an image processing location designating means 26 for designating the location at which image processes are to be administered on the image data S0 based on the intended use of the image data S0 and/or desired image quality thereof, as will be described below, and generating location data B0; an input means 27 comprising a plurality of buttons for performing various types of input, such as photography operations by the camera 21, transmission commands for the image data S0, input of the intended use and/or the desired image quality of the image data S0, the transmission destination of the image data S0 or the processed image data S2, specification of whether printing is to be performed, specification of whether the image data is to be stored in the image server 3, commands for administering image processes on the image data S0, and image correction commands; and an image correcting means 28 for administering image correction processes on the processed image data S1 to obtain corrected processed image data S2′, in response to input from the input means 17 by a user of the cellular telephone with built in camera 1.

Note that in the present embodiment, the image data S0 is obtained by the cellular telephone with built in camera 1, image processes and image correction processes are both administered on the image data S0 by the cellular telephone with built in camera 1, and the image data S0 or the corrected processed image data S1′ is transmitted to the image server 3.

In addition, in the present embodiment, the image processing location at which image processes are to be administered on the image data S0 is designated to be at the cellular telephone with built in camera 1, and the cellular telephone with built in camera 2 is specified as one of the transmission destinations of the image data S0 or the corrected processed image data S1′.

The image processing means 13 obtains processed image data S1 by administering image processes, such as density correction, white balance adjustment, gradation correction, color correction, and a sharpness process, on the image data S0. Note that the image processing means 13 is not capable of performing image processes as advanced as image processing means of the image server 3 or the laboratory 4, to be described later. Accordingly, the obtained processed image data S1 is suitable for display on the LCD monitor 14, but not suitable for printing or for display on a large monitor such as that of a PC.

The image processing location designating means 16 designates the location at which image processes are to be administered on the image data S0 based on the intended use of the image data S0 and/or the desired image quality thereof, input by the user from the input means 17, and generates location data B0 regarding the location at which image processes are to be administered. For example, in the case that the intended use of the image data S0, input by the user, is for display on the monitor of a cellular telephone, and/or that the desired image quality is low, high image quality is not required of the image data S0. Therefore, the image processing location designating means 16 designates the location of image processing to be the cellular telephone with built in camera 1, and generates location data B0. Note that in the case that the image data S0 is to be transmitted to the cellular telephone with built in camera 2, the image processing location may be designated to be the cellular telephone with built in camera 2, and the location data B0 may be generated to indicate such a designation. In this case, the designation of the image processing location may be performed based on the transmission destination data for the image data S0, input from the input means 17.

Note that the intended use and/or the desired image quality may be directly input from the input means 17. Alternatively, a configuration may be adopted wherein a variety of intended uses and/or levels of image quality are displayed on the LCD monitor 14, and the user selects a desired intended use and/or a level of image quality.

In addition, in the case that the intended use of the image data S0 is storage in the image server 3, the image data S0 is employed by being downloaded from the image server 3 to a terminal apparatus such as a PC, and displayed on a monitor thereof. Therefore, a mid-level image quality which is not as high as that for printing is required. Accordingly, in the case that the intended use and/or desired image quality input from the input means 17 is storage in the image server 3 and/or mid-level image quality, the image processing location designating means 16 designates the image server 3 as the image processing location and generates location data B0 indicating such designation.

Further, in the case that the intended use of the image data S0 is printing, high image quality is required of the image data S0. In addition, in the case that the desired image quality is high, it is often the case that printing is desired. Accordingly, in the case that the intended use and/or desired image quality input from the input means 17 is printing and/or high image quality, the image processing location designating means 16 designates the laboratory 4 as the image processing location and generates location data B0 indicating such designation.

The image correcting means 18 obtains corrected processed image data S1′ by administering image correction processes on the processed image data S1 in response to input by the user from the input means 17. Specifically, the density, the density of each color (cyan, magenta, and yellow), the white balance, the gradation, the color, and the sharpness of an image displayed on the LCD monitor 14 representing the processed image data S1, is corrected based on user input from the input means 17. Here, each of the buttons comprising the input means is designated with a function of adjusting the density of the entire image, the density of cyan, the density of magenta, the density of yellow, the white balance, the gradation, the color, and the sharpness, respectively. By the user operating the specified input means, the density of the entire image, the density of cyan, the density of magenta, the density of yellow, the white balance, the gradation, the color, and the sharpness can be corrected.

Note that in the case that the image processing location is the cellular telephone with built in camera 1, and no image correction is performed, the processed image data S1 is transmitted to the image server 3 as is. However, in this case it is assumed that correction is performed on the processed image data S1, with correction amounts of 0. Therefore, this image data is designated as corrected processed image data S1′.

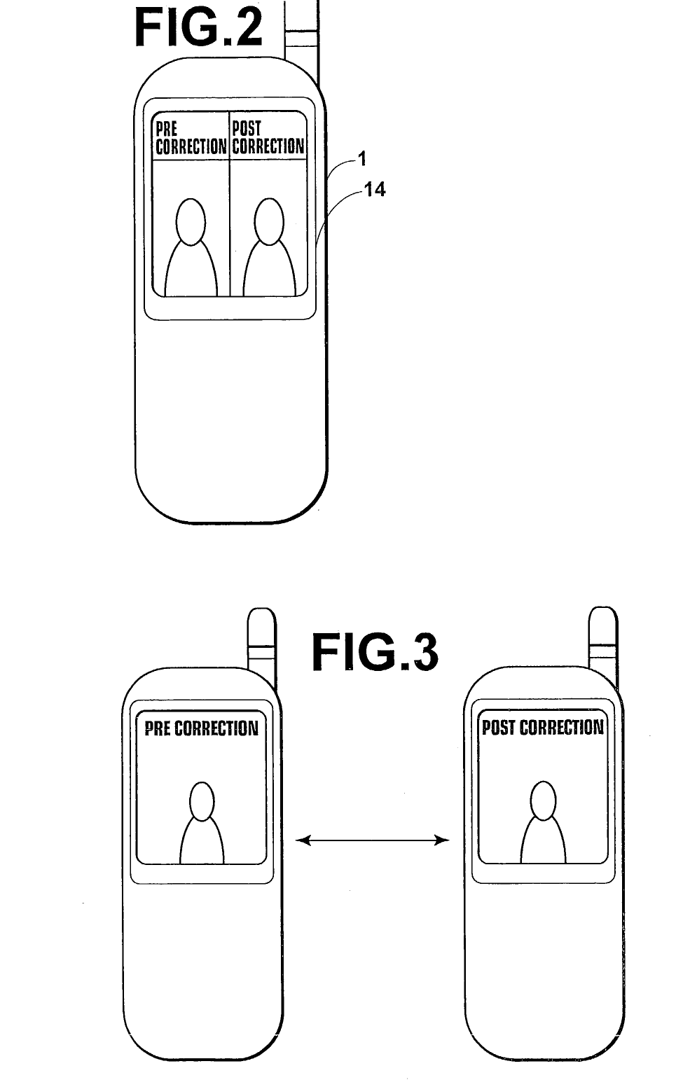

The image data S0 and the corrected processed image data S1′ may be displayed on the LCD monitor 14 in a divided display manner by operating the input means 17. FIG. 2 shows a state in which the image data S0 and the corrected processed image data S1′ are displayed on the LCD monitor 14 in a divided display manner. Note that because it is difficult to display the entireties of the images representing the image data S0 and the corrected processed image data S1′ on the LCD monitor 14 simultaneously, the images are trimmed, and the central portions thereof are displayed. In addition, in order to clarify which of the two images is the corrected image, the original image is labeled “Pre-Correction” and the corrected image is labeled “Post-Correction”.

Note that instead of dividing the LCD monitor 14 into sections, the original image and the corrected image may be displayed alternately thereon. In this case, the image displayed may be switched by an operation of the input means 17. Alternatively, the display of the original image and the corrected image may be switched at intervals of a predetermined time period (for example, two seconds).

In addition, the image data to be transmitted to the image server 3 is selected by an operation of the input means 17 by the user of the cellular telephone with built in camera 1.

The communication means 12 transmits the image data S0 or the corrected processed image data S1′ to the image server 3 via the cellular telephone communication network 5. The location data B0 and transmission destination data that represents the transmission destination (such as the laboratory 4, the cellular telephone with built in camera 2, an e-mail address of a friend of the user of the cellular telephone with built in camera 1) of the image data S0 or the corrected processed image data S1′ is transmitted along with the transmitted image data. Note that in the case that the intended use of the image data S0 is printing, receiver data that represents a receiver of the prints (the receiver data may be any data as long as the receiver can be specified; for example, a cellular telephone number will suffice) is also transmitted.

Here, the only cases in which the unprocessed image data S0 is transmitted is when the image processing location has been designated to be the image server 3, the laboratory 4, or the cellular telephone with built in camera 2. On the other hand, in the case that the cellular telephone with built in camera 1 is designated as the image processing location, image processes are administered on the image data S0 by the image processing means 13 to obtain processed image data S1. Further, the processed image data S1 is corrected as described above to obtain corrected processed image data S1′. Then, the corrected processed image data S1′ is transmitted to the image server 3 along with the location data B0 (in this case, representing the cellular telephone with built in camera 1).

Note that the communication means 22, the image processing means 23, the image processing location designating means 26 and the image correcting means 28 of the cellular telephone with built in camera 2 have the same functions as the communication means 12, the image processing means 13, the image processing location designating means 16 and the image correcting means 18, respectively.

The image server 3 comprises: a communication means 31 for transmitting and receiving various types of data such as the image data S0; an image processing means 32 for administering image processes on the image data S0 to obtain processed image data S3; a storage means 33 for storing the image data S0 or the corrected processed image data S1′ which has been transmitted from the cellular telephone with built in camera 1; a URL generating means 34 for generating a URL representing the storage location of the image data S0 or the corrected processed image data S1′; an e-mail generating means 35 for generating an e-mail message with the URL generated by the URL generating means 34 attached thereto; and a controller 36 for controlling the operations of the image server 3.

The image processing means 32 administers image processes, such as density correction, white balance adjustment, gradation correction, color correction, and a sharpness process, on the image data S0 to obtain processed image data S3, in the case that the image data S0 is transmitted to the image server 3 and the image processing location indicated by the location data BO is the image server 3. Note that the image processes performed by the image processing means 32 are those that enable display of the processed image data S3 on a monitor at a suitable image quality.

The storage means 33 stores the corrected processed image data S1′ in the case that the corrected processed image data S1′ is transmitted from the cellular telephone with built in camera 1. In the case that unprocessed image data S0 has been transmitted and the image processing location indicated by the location data B0 is the image server 3, the storage means 33 stores the processed image data S3 obtained by the image processing means 32. Further, in the case that unprocessed image data S0 has been transmitted and the image processing location indicated by the location data B0 is the cellular telephone with built in camera 2 or the laboratory 4, the storage means 33 stores the unprocessed image data S0.

The URL generating means 34 generates a URL that represents the storage location of the image data S0, the corrected processed image data S1′, or the processed image data S3.

The e-mail generating means 35 generates an e-mail message with the URL generated by the URL generating means 34 attached thereto, based on the transmission destination data which has been transmitted along with the image data S0 or the corrected processed image data S1′. Note that the generated e-mail message is transmitted to the transmission destination indicated by the transmission destination data by the communication means 31 via the cellular telephone communication network 5.

The laboratory 4 comprises: a communication means 41 for transmitting and receiving various types of data such as the image data S0; an image processing means 32 for administering image processes on the image data S0 to obtain processed image data S4; a printer 43 for printing the processed image data S4 to obtain a print P; a notification means 44 for notifying the cellular telephone with built in camera 1 that printing has been completed; and a controller 45 for controlling the operations of the laboratory 4.

When the laboratory 4 receives an e-mail transmitted thereto by the image server 3, the communication means 41 refers to the URL attached to the e-mail message and downloads the image data S0 from the storage means 33 of the image server 3. Note that the receiver data that indicates the receiver of the prints P is downloaded simultaneously with the image data S0.

The image processing means 42 administers image processes, such as density correction, white balance adjustment, gradation correction, color correction, and a sharpness process, on the image data S0 downloaded from the storage means 33 of the image server 3 to obtain processed image data S4. Here, in the case that the e-mail message is transmitted to the laboratory 4, it is clear that the image processes are to be administered to the image data S0 at the laboratory 4. However, it is preferable to refer to the location data B0 to confirm that the image processing location is the laboratory 4. Note that the image processes performed by the image processing means 42 are those that enable printing of the processed image data S4 at a suitable image quality.

The notification means 44 notifies the receiver of the prints, indicated by the receiver data, that printing has been completed, when printing of the processed image data S4 is complete. The notification may be in the form of an e-mail message or an automated voice message transmitted by telephone. Alternatively, an operator at the laboratory 4 may call the receiver on the telephone, or transmit an e-mail message to the receiver by a manual operation.

Note that in the case that the image server 3 transmits the e-mail message to the cellular telephone with built in camera 2, the user of the cellular telephone with built in camera 2 refers to the URL, accesses the storage means 33 of the image server 3, and downloads the image data S0 or the corrected processed image data S1′. Note that in the case that the corrected processed image data S1′ is downloaded, the corrected processed image data S1′ is displayed on the LCD monitor 24 as is. On the other hand, in the case that the image data S0 is downloaded, image processes are administered thereon by the image processing means 23 to obtain processed image data S2, which is then displayed on the LCD monitor 24. Further, image correcting processes are administered on the processed image data S2 by the image correcting means 28, in accordance with user operation of the cellular telephone with built in camera 2, to obtain corrected processed image data S2′, which is then displayed on the LCD monitor 24.

Note that in the case that the email message with the URL indicating the storage location of the unprocessed image data S1 attached thereto is transmitted to the cellular telephone with built in camera 2, it is clear that image processes are to be administered on the image data S0 at the cellular telephone with built in camera 2. However, it is preferable to refer to the location data B0 to confirm that the image processing location is the cellular telephone with built in camera 2.

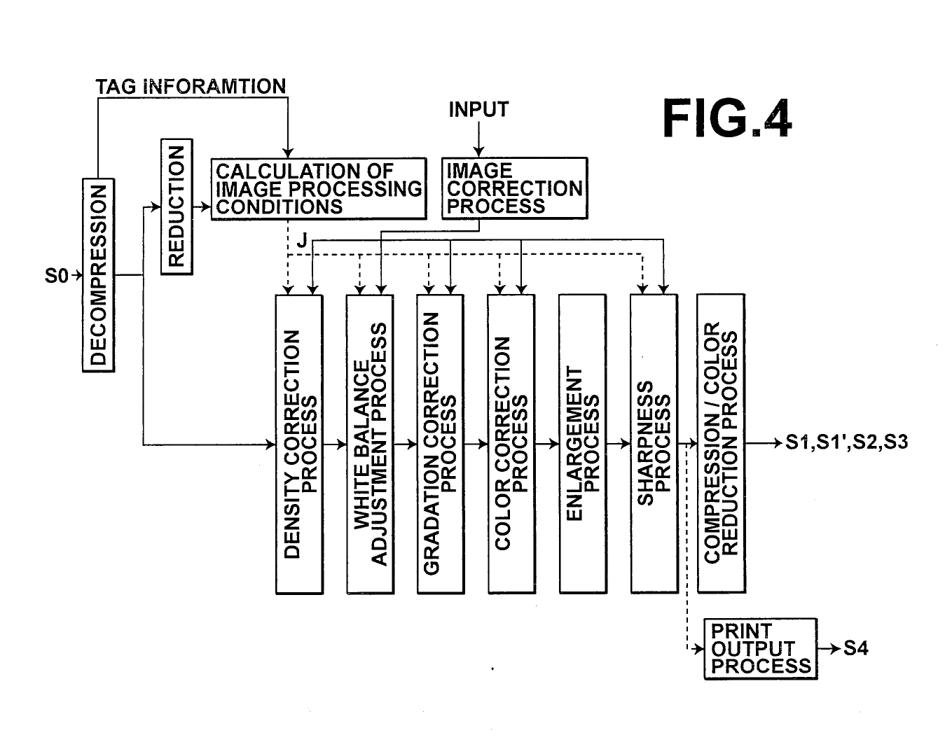

The processes performed by the image processing means 13 and the image correcting means 18 will be described. FIG. 4 is a schematic block diagram that shows the processes which are performed by the image processing means 13 and the image correcting means 18. First, the processes performed by the image processing means 13 will be described.

The image data S0 is compressed in JPEG format or the like. Therefore, first, the image data S0 is decompressed, then reduced in size by the image processing means 13, as shown in FIG. 4. Then, image processing conditions J for use in image processing are calculated, based on the reduced image data S0 and tag information attached thereto, describing the photography conditions during photography thereof.

Then, processed image data S1 is obtained by administering image processes, such as density correction, white balance adjustment, gradation correction, color correction, and a sharpness process, on the image data S0, based on the calculated image processing conditions J. Note that although not based on the image processing conditions J, an enlargement process is performed so as to match the size of the image represented by the image data S0 to its output size (print size, monitor size, etc.) prior to the administration of the sharpness process. Here, enlargement processes include those that employ magnifications of less than 1×.

Here, the density correction and white balance processes correct exposure errors and white balance errors during photography. The gradation process absorbs the differences in contrast between the scene of photography and a print. The color correction process corrects the hue, chroma and brightness of each of the colors Red Green and Blue. The sharpness process corrects the sharpness of the image.

The density (density of the entire image, density of cyan, density of magenta, and density of yellow); the white balance; the gradation; the color; and the sharpness of the image represented by the processed image data S1 is corrected by the image correcting means 18, based on user input from the input means 17 of the cellular telephone with built in camera 1.

Note that image processing is performed in the same manner as described above by the image processing means 23 of the cellular telephone with built in camera 2, the image processing means 32 of the image server 3, and the image processing means 42 of the laboratory 4. In addition, image correction processes may be administered on the processed image data S2, S3, and S4 by the cellular telephone with built in camera 2, the image server 3, and the laboratory 4. Note that at the cellular telephone with built in camera 2, image correction processes are administered on the processed image data S2 by the image correcting means 28.

There are limitations in the transmission capacity and the color display ability of the display medium of the cellular telephones with built in cameras 1 and 2, and the image server 3. Therefore, processed image data S1, S2, or S3, or corrected processed image data S1′ is obtained by performing compression processes to reduce the amount of data, color reduction processes to reduce the number of colors, or the like following the sharpness process, as shown in FIG. 4. The LCD monitors 14 and 24 of the cellular telephones with built in cameras 1 and 2 have narrower color reproduction ranges than a monitor of a PC. Therefore, color reduction processes are performed so as to effectively utilize the narrow color reproduction ranges thereof.

In addition, image processes are administered on the image data S0 by simpler calculations at the image processing means 13 and 23 of the cellular telephones with built in cameras 1 and 2, compared to those of the image processing means 32 and 42 of the image server 3 and the laboratory 4. Further, there are cases in which the color correction process and the sharpness process are omitted by the image processing means 13 and 23.

On the other hand, processed image data S4 is obtained by performing a print output process that converts the image data to device signals of the printer 43 following the sharpness process in the image processing means 42 of the laboratory 4, as indicated by the broken line in FIG. 4.

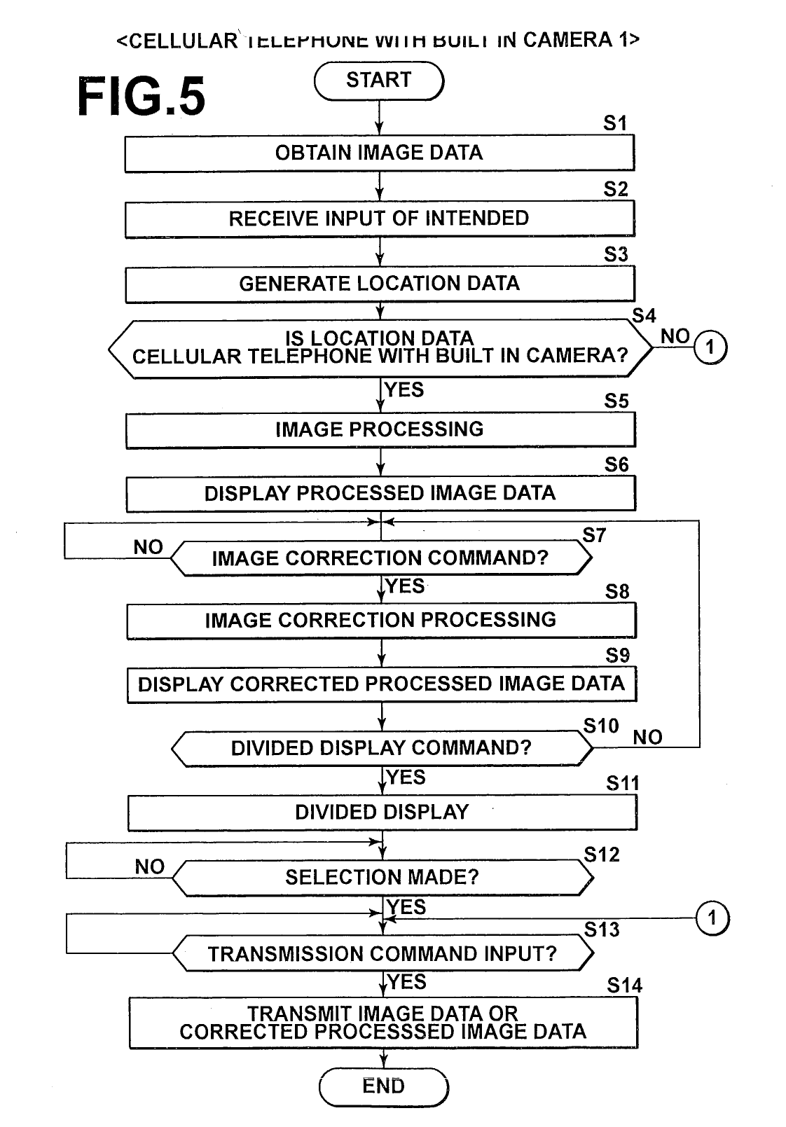

Next, the operation of the present embodiment will be described. FIG. 5 is a flow chart that shows the processes performed by the cellular telephone with built in camera 1. First, image data S0 is obtained by the camera 11 (step S1). The intended use and/or desired image quality for the image data S0 is input by the user of the cellular telephone with built in camera 1 at the input means 17 (step S2). Then, the image processing location designating means 16 designates the image processing location at which image processes are to be administered on the image data S0, based on the input intended use and/or the desired image quality, and location data B0 is generated (step S3).

Next, the controller 15 judges whether the image processing location is the cellular telephone with built in camera, by referring to the location data B0 (step S4). In the case that the judgment in step S4 is affirmative, the image processing means 13 administers image processes on the image data S0 to obtain processed image data S1 (step S5). Then, the processed image data S1 is displayed on the LCD monitor 14 (step S6). Note that in the case that the judgment in step S4 is negative, the operation proceeds to step S13, to be described later.

Thereafter, whether an image correction command has been input by the user of the cellular telephone with built in camera 1 is judged (step S7). If the judgment in step S7 is affirmative, image correction processes are administered on the processed image data S1 by the image correcting means 18, and corrected processed image data S1′ is obtained (step S9). The corrected processed image data S1′ is then displayed on the LCD monitor 14.

Next, whether the user has issued a divided display command is judged (step S10). If the judgment in step S10 is affirmative, an original image that represents the image data S0 and a corrected image that represents the corrected processed image data S1′ are displayed on the LCD monitor 14 in a divided display manner (step 11). Note that if the judgment in step S10 is negative, the operation returns to step S7.

Then, monitoring is initiated to judge whether one of the original image and the corrected image is selected (step 12). If the judgment in step S12 is affirmative, monitoring is initiated to judge whether a transmission command is input by the user (step S13) If the judgment in step S13 is affirmative, the image data S0 or the corrected processed image data S1′ is transmitted to the image server 3 (step S14), along with the location data B0, the transmission destination data, and, in the case that printing is requested, the receiver data for the prints P. The processes performed by the cellular telephone with built in camera 1 are thus completed.

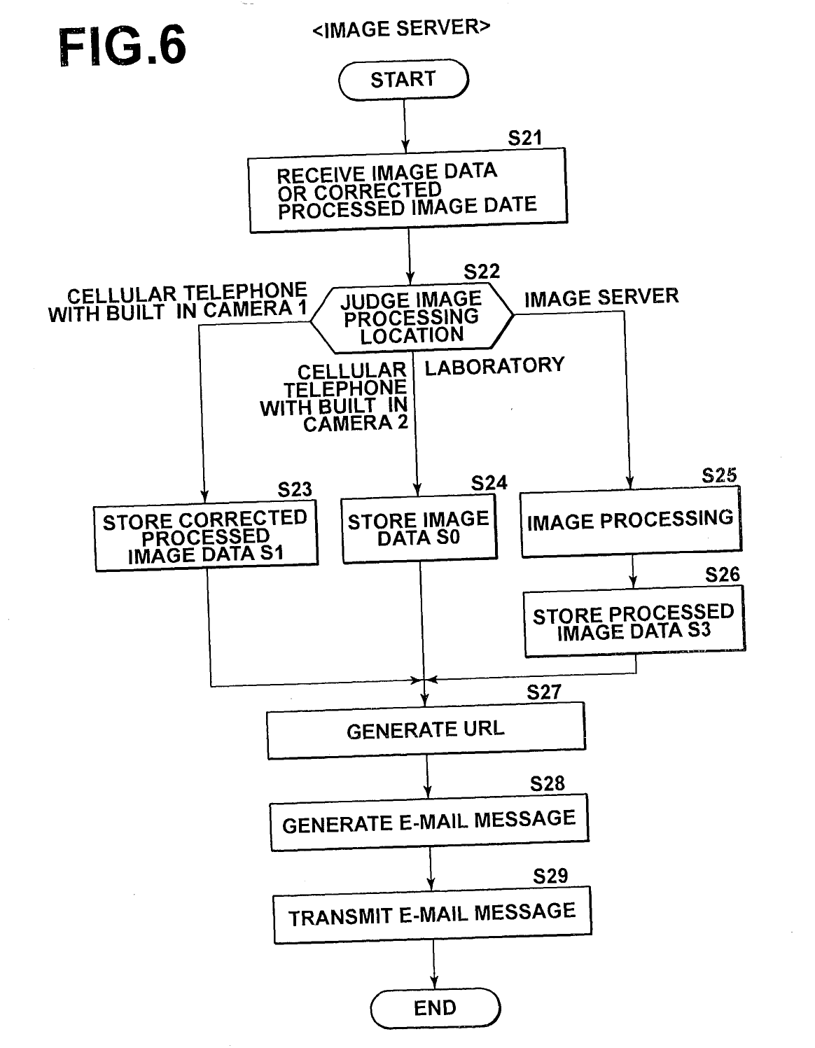

FIG. 6 is a flow chart that shows the processes performed by the image server 3. First, the image data S0 or the corrected processed image data S1′ transmitted by the cellular telephone with built in camera 1 is received (step S21). Then, the image processing location of the image data S0 is judged, based on the location data B0 attached to the image data S0 or the corrected processed image data S1′ (step S22).

In the case that the image processing location is judged to be the cellular telephone with built in camera 1, it is known that the corrected processed image data S1′ has been transmitted. Therefore, the corrected processed image data S1′ is stored in the storage means 33 (step S23). In the case that the image processing location is judged to be the cellular telephone with built in camera 2 or the laboratory 4, the unprocessed image data S0 is stored in the storage means (step S24). In the case that the image processing location is judged to be the image server 3, image processes are administered on the image data S0 by the image processing means 32 to obtain processed image data S3 (step S25). Then, the processed image data S3 is stored in the storage means 33 (step S26).

After the image data S0, the corrected processed image data S1′, or the processed image data S3 is stored in the storage means 33, the URL generating means generates a URL that represents the storage location of the image data S0, the corrected processed image data S1′, or the processed image data S3 (step S27). Then, the e-mail generating means 35 generates an e-mail message with the URL attached thereto (step S28). Finally, the e-mail message is transmitted to a transmission destination according to the transmission destination data, which had been attached to the image data S0 or the corrected processed image data S1′ (step S29), and the processes performed by the image server 3 are thus completed.

Note that in the case that the transmission destination of the e-mail message is the cellular telephone with built in camera 2, a description is given in the e-mail message as to whether the URL attached thereto indicates the storage location of the image data S0 or the corrected processed image data S1′.

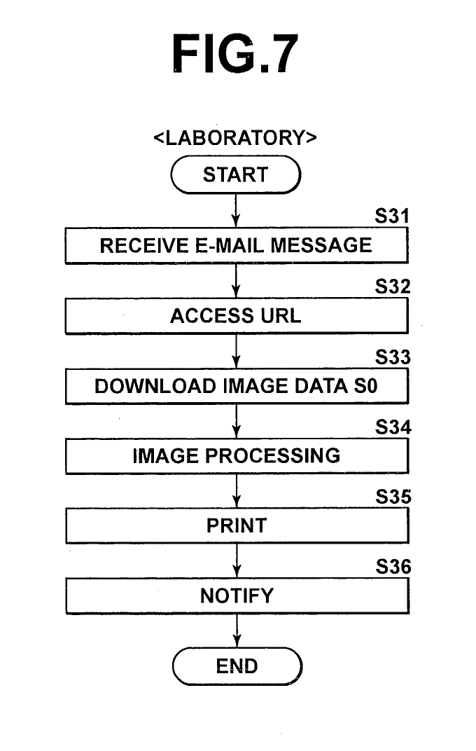

FIG. 7 is a flow chart that shows the processes performed by the laboratory 4. First, the e-mail message transmitted by the image server 3 is received (step S31). Next, the communication means 41 accesses the URL attached to the e-mail message (step S32), and the image data S0 is downloaded (step S33). Then, the image processing means 42 administers image processes on the image data S0 to obtain processed image data S4 (step S34). The processed image data S4 is output by the printer 43, and prints Pare obtained (step S35). When printing is completed, the notification means 44 notifies the receiver of the prints P that the printing has been completed (step 36), thus completing the processes performed by the laboratory 4.

Note that the prints P may be picked up at the laboratory 4 by the receiver of the prints P (for example, the user of the cellular telephone with built in camera 1) who has been notified by the notification means 44, or they may be delivered to the receiver.

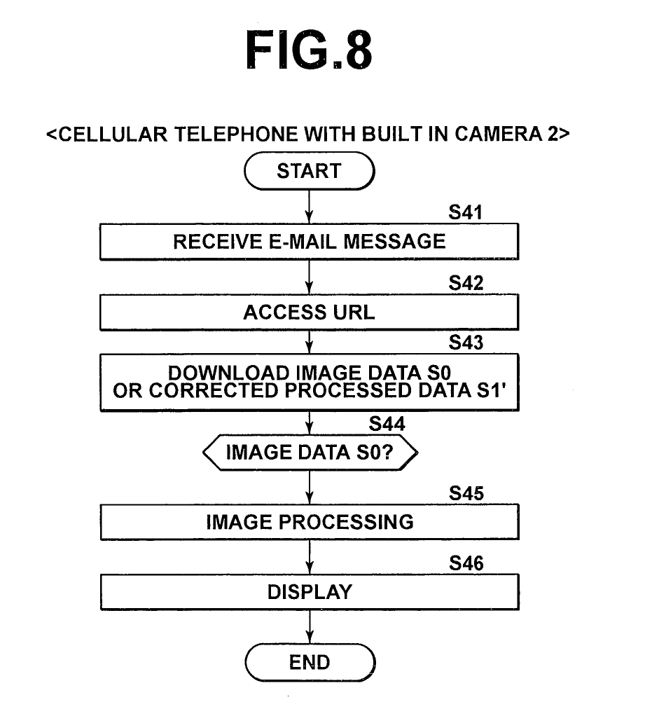

FIG. 8 is a flow chart that shows the processes performed by the cellular telephone with built in camera 2. First, the e-mail message transmitted by the image server 3 is received (step S41). Next, the communication means 22 accesses the URL attached to the e-mail message (step S42), and the image data S0 or the corrected processed image data S1′ is downloaded (step S43).

Then, whether the downloaded image data is the unprocessed image data S0 is judged based on the description in the e-mail message (step S44). If the judgment in step S44 is affirmative, it is judged that the unprocessed image data S0 has been downloaded. Therefore, the image processing means 23 administers image processes to the image data S0 to obtain processed image data S2 (step S45). The processed image data S2 is displayed on the LCD monitor 24 (step S46), thus completing the processes performed by the cellular telephone with built in camera 2.

On the other hand, if the judgment in step S44 is negative, it is judged that the corrected processed image data S1′ has been downloaded. Therefore, the corrected processed image data S1′ is displayed on the LCD monitor 24 (step S46), thus completing the processes performed by the cellular telephone with built in camera 2.

According to the present embodiment, corrected processed image data S1′ is obtained by administering image correction processes according to user commands on processed image data S1, which is obtained by the image processing means 13 of the cellular telephone with built in camera 1. Therefore, corrected processed image data S1′, that reflects the intentions of the user of the cellular telephone with built in camera 1, or image data S0, that reflects the user's intention not to perform image processes or image correction processes at the cellular telephone with built in camera 1, can be transmitted to the image server 3.

In addition, the image data S0 and the corrected processed image data S1′ are displayed on the LCD monitor 14 in a divided display manner; a transmission command is received for either the image data S0 or the corrected processed image data S1′; and the image data S0 or the corrected processed image data S1′, for which the transmission command has been received, is transmitted. By adopting this configuration, either the image data S0 or the corrected processed image data S1′, the selection between which positively reflects the intentions of the user regarding image processing, can be transmitted to the image server 3.

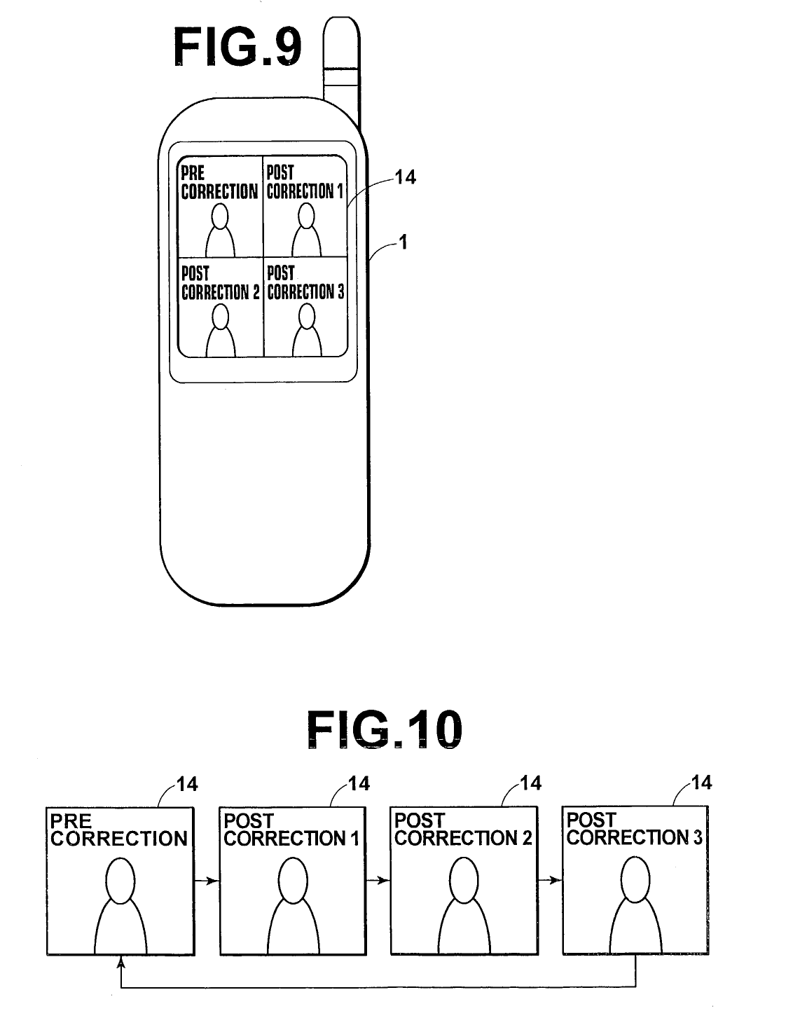

Note that in the embodiment described above, the image data S0 and one corrected processed image data S1′ are displayed on the LCD monitor 14. Alternatively, a plurality of corrected processed image data, which has been corrected in a plurality of steps, and the image data S0 may be displayed on the LCD monitor in a divided display manner. For example, in the case that three corrected processed image data are obtained by correcting the image data S0 in three steps, the LCD monitor 14 may be quartered to display the original image prior to correction and the three corrected images (corrected images 1 through 3), as shown in FIG. 9. Alternatively, the four images may be displayed sequentially, as shown in FIG. 10.

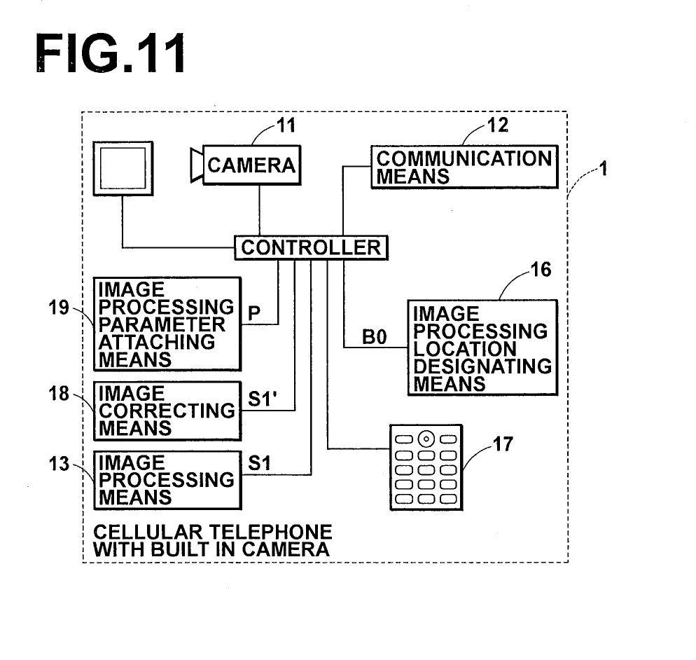

Further, in the embodiment described above, the corrected processed image data S1′ is transmitted to the image server 3. Alternatively, image processing parameters necessary to obtain the corrected processed image data S1′ may be attached to the image data S0 and transmitted to the image server 3. In this case, the cellular telephone with built in camera 1 further comprises an image processing parameter attaching means 19 for attaching the image processing parameters PM to the image data S0, as shown in FIG. 11. In addition, the image processing parameters PM may be transmitted as a file separate from the image data S0.

In addition, the cellular telephone with built in camera 2 is designated as one of the transmission destinations of the image data S0 or the corrected processed image data S1′. However, the transmission destination may alternatively be a portable terminal apparatus such as a cellular telephone without a built in camera, a PDA, or the like.

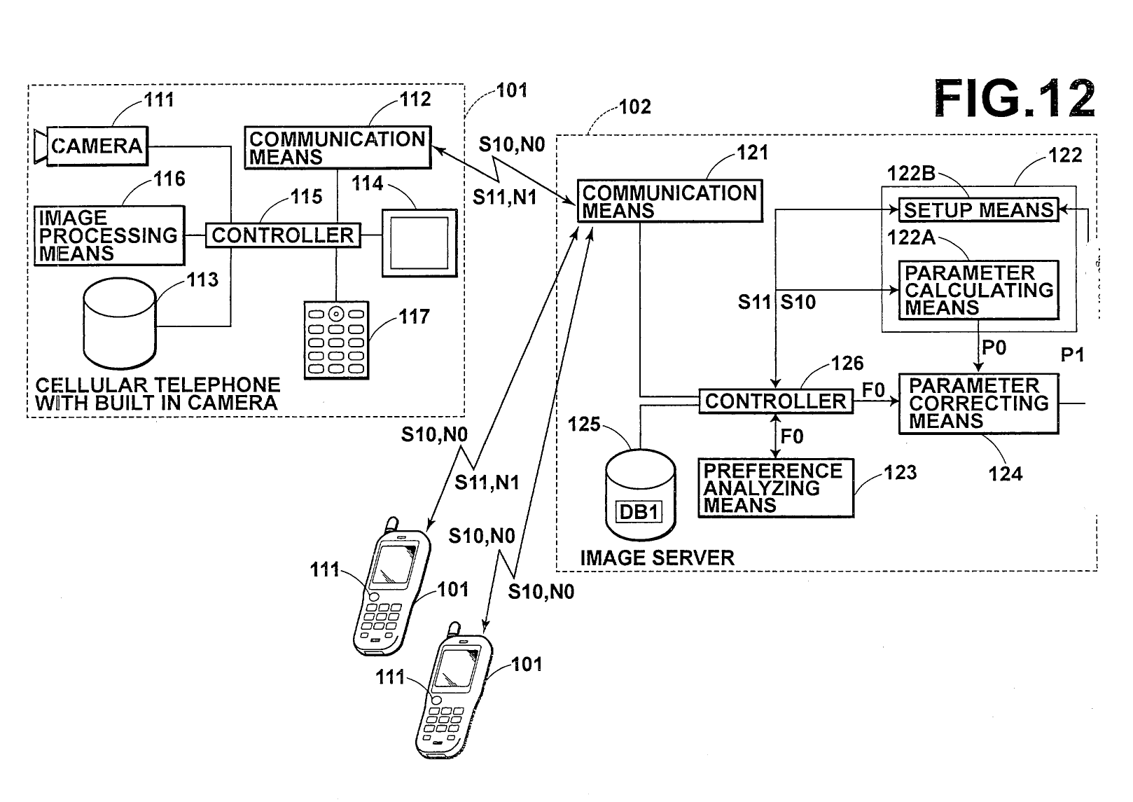

Next, an embodiment of the method and apparatus for image processing of the present invention will be described. FIG. 12 is a schematic block diagram illustrating an image processing system comprising an image processing apparatus according to an embodiment of the present invention. As shown in FIG. 12, the image processing system according to the present embodiment comprises a cellular telephone with built in camera 101 and an image server 102 for administering image processes on image data S10 obtained by the cellular telephone with built in camera 101. Data is exchanged among the constituents of the system.

The cellular telephone with built in camera 101 comprises: a camera 111 for obtaining image data S10 by photography; a communication means 12 for transmitting and receiving various types of data including the image data S10 via a cellular telephone communications network; a memory 113 for recording various types of data including the image data S10; an LCD (Liquid Crystal Display) monitor 114 for performing various types of display including images and telephone numbers; a controller 115 for controlling the operations of the cellular telephone with built in camera 1; and an image processing means 116 for administering image processes on the image data S10.

Note that photography operations by the camera 111, transmission and reception commands for the image data S10, image processing commands and the like are performed by an input means 117 comprising a plurality of buttons for performing various types of input, provided on the cellular telephone with built in camera 101.

In addition, the image processing means 116 is that which is capable of administering image processes on the image data S10 as well as reference image data NO, to be described later, according to user commands from the input means 117.

A user of the cellular telephone with built in camera 101 obtains image data S10 by performing photography employing the camera 111. The obtained image data S10 may be: displayed on the LCD monitor 114 and set as the wallpaper of the cellular telephone; transmitted to the image server 102 to administer image processes thereon; or sent to a cellular telephone with built in camera of a friend, via the image server 102.

The image server 102 comprises: a communication means 121 for transmitting and receiving various types of data including the image data S10 via a cellular telephone communications network; an image processing means 122 for administering image processes on the image data S10 to obtain processed image data S11; a preference analyzing means 123 for analyzing the preferences of the user who has requested image processes to be administered on the image data S10, as will be described later; a parameter correcting means 124 for correcting calculated image processing parameters PM0 to obtain corrected image processing parameters PM1; a storage means 125 that stores a database DB1 which has recorded therein preference data F0 for a plurality of users; and a controller 126 for controlling the operations of the image server 102.

The image processing means 122 comprises a parameter calculating means 122A for calculating image processing parameters PM0 for density correction, white balance adjustment, gradation conversion, color correction, a sharpness process, etc., based on the image data S10; and a setup means 122B for administering image processes on the image data S10 to obtain image data S1. Note that the image processing means 122 performs more advanced processes than the image processing means 116 of the cellular telephone with built in camera 101, and is capable of obtaining processed image data S11 that represents an image of a higher image quality.

The preference analyzing means 123 has the user of the cellular telephone with built in camera 101 correct a reference image, which will be the basis of image processing. The preferences of the user are analyzed based on a corrected reference image obtained thereby, and preference data F0 is obtained by the analysis. Here, the reference image includes predetermined charts, base skin tones and the like. The image server 102 transmits reference image data NO that represents the reference image to the cellular telephone with built in camera 101.

The reference image data NO received by the cellular telephone with built in camera 101 is displayed on the LCD monitor 114. The image processing means 116 administers image processes that reflect the preferences of the user on the reference image data NO, according to commands input by the user from the input means 117. Corrected reference image data N1 is thus obtained. The corrected reference image data N1 is transmitted to the image server 102. The corrected reference image data N1 reflects the preferences of the user regarding image processes, such as to redden skin tones, to harden gradation, to decrease density, etc.

The preference analyzing means 123 analyzes the user's preferences based on the corrected reference image data N1, and obtains preference data F0. The preference data F0 includes parameters for adjusting the image processing parameters PM0 to reflect the user's preferences, such as to redden skin tones, to harden gradation, to decrease density, etc.

The preference data F0 is recorded in the database DB1 for each user, and stored in the storage means 125. Note that the readout of the preference data F0 for each user is performed based on the user data which is transmitted by the user at the time when image processes are requested for the image data S10. Specific examples of the user data include: the telephone number of the cellular telephone with built in camera 101, a user number registered in advance by the user, and the user's name. Note that in the present embodiment, the telephone number of the cellular telephone with built in camera 101 is employed as the user data.

Note that the obtainment of the preference data F0 based on the corrected reference image data N1 is performed the first time that the user of the cellular telephone with built in camera 101 requests image processes for the image data S10 at the image server 102. In addition, the preference data F0 may be updated as requested by the user.

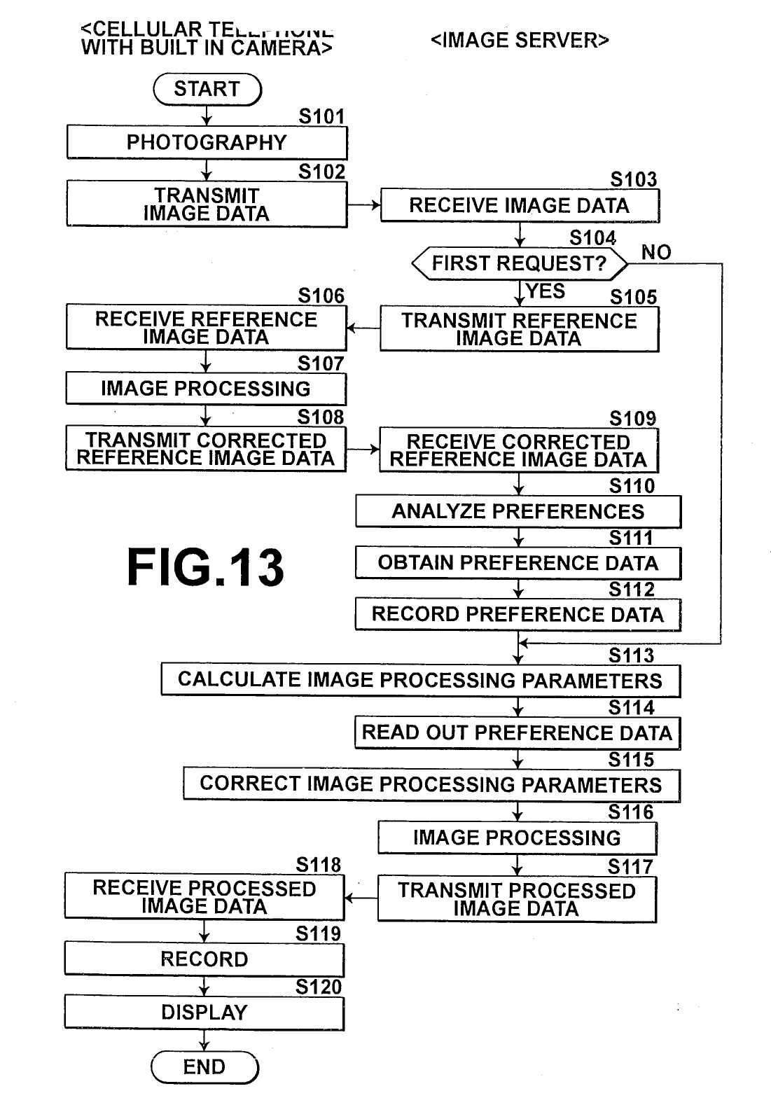

Next, the operation of the present embodiment will be described. FIG. 13 is a flow chart that shows the processes performed in the present embodiment. First, photography is performed by the cellular telephone with built in camera 101 employing the camera 111, to obtain image data S10 (step S101). The obtained image data S10 is transmitted to the image server 102 by the communication means 112 (step S102). At this time, the telephone number of the cellular telephone with built in camera 101 is transmitted to the image server, as user data.

The transmitted image data S10 is received by the communication means 121 of the image server 102 (step S103). Then, whether the image processing request by the user who transmitted the image data S10 is the user's first request is judged, based on the telephone number transmitted with the image data S10 (step S104). If the judgment in step S104 is affirmative, reference image data NO is transmitted by the communication means 121 to the cellular telephone with built in camera 101, to analyze the user's preferences (step S105). In the case that the judgment in step S104 is negative, it is determined that the preference data F0 representing the preferences of the user is already recorded in the database DB1, and the operation proceeds to step S113.

The reference image data NO transmitted by the image server 102 is received by the communication means 112 of the cellular telephone with built in camera 101 (step S106). Image processes reflecting the preferences of the user are administered on the reference image data NO by the user (step S107), and corrected reference image data N1 is obtained. The image processes are administered on the reference image data NO by displaying the reference image data NO on the LCD display 114, and the user entering image processing commands from the input means 117. The corrected reference image data N1 is transmitted to the image server 102 by the communication means 112 (step S108).

The transmitted corrected reference image data N1 is received by the communication means 121 of the image server 102 (step S109). Then, the user's preferences are analyzed by the preference analyzing means 123 (step S110) and preference data F0 is obtained (step 111). The preference data F0 is recorded in the database DB1, which is stored in the storage means 125 (step S112).

At step S113, the parameter calculating means 122A calculates image processing parameters PM0 based on the image data S10 (step S113). Next, the preference data F0 of the user who requested image processing is read out from the database DB1, based on the telephone number transmitted along with the image data S10 (step S114). Then, the image processing parameters PM0 are corrected according to the read out preference data F0, and corrected image processing parameters PM1 are obtained (step S115).

Next, processed image data S11 is obtained by the setup means 122B by administering image processes on the image data S10 based on the corrected image processing parameters PM1 (step S116). The processed image data S11 is transmitted to the cellular telephone with built in camera 101 by the communication means 121 (step S117).

The transmitted processed image data S11 is received by the communication means 112 of the cellular telephone with built in camera 101 (step S118), recorded in the memory 113 (step S119), and displayed on the LCD monitor 114 (step S120). The processes performed by the image processing system are thus completed.

According to the present embodiment, user data that specifies the user who requested image processing to be performed by the image server 102 is obtained; preference data F0 is retrieved by referring to a database DB1 that records therein preference data F0 representing preferences regarding image processing for each user; image processing parameters PM0 are corrected to obtain corrected image processing parameters PM1 based on the preference data F0; and image processes are administered on the image data S10 based on the corrected image processing parameters PM1. Therefore, the image represented by the processed image data S11 is enabled to be that which reflects the preferences of the user who requested image processing.

In addition, the preference data F0 is obtained by: transmitting the reference image data NO to the cellular telephone with built in camera 101; having the user administer image processes that reflect his/her preferences on the reference image data NO to obtain the corrected reference image data N1; and analyzing the corrected reference image data N1. Therefore, preference data F0 for each data can be obtained in a simple manner.

Note that in the embodiment of the image processing system comprising the image processing apparatus according to the present invention described above, the preference data F0 is obtained based on analysis of corrected reference image data N1, which is obtained by having the user correct the reference image data NO. Alternatively, the user may be asked about his/her preferences, and the preference data F0 maybe generated based on the user's responses, then recorded in the database DB1. For example, the user may be asked whether he/she prefers: bright images or dark images; high contrast images or low contrast images; etc. An operator at the image server 102 may generate preference data F0 that represents the user's preferences based on the responses to the above questions. In this case, bright images and dark images, or high contrast images and low contrast images may be displayed to the user, and the responses may be obtained by having the user issue commands selecting the image that he/she prefers.

In addition, in the embodiment of the image processing system comprising the image processing apparatus according to the present invention, images are displayed on the cellular telephone with built in camera 101. However, the present invention may be applied to the display of images on various types of portable terminal apparatuses, such as PDA's.

What is claimed is:

1. An image data transmission method for use by a portable terminal apparatus comprising:
a photography means for obtaining image data by photography;
a communication means for transmitting and receiving data;
an image processing means for administering image processes on the image data to obtain processed image data; and
a display means for performing display in various modes; the method comprising the steps of:
receiving an input of an image correction command for the processed image data;
administering image correction processes on the processed image data to obtain corrected processed image data; and
transmitting the image data or the corrected processed image data to an image server for storing and managing the image data or the corrected processed image data.

2. An image data transmission method as defined in claim 1, further comprising the steps of:
displaying the image data and the corrected processed image data on the display means in a divided display manner;
receiving a transmission command for either the image data or the corrected processed image data; and
transmitting either the image data or the corrected processed image data, for which the transmission command was received, to the image server.

3. An image data transmission method as defined in claim 1, further comprising the steps of:
displaying a plurality of corrected processed image data, which has been corrected in a plurality of steps, and the image data on the display means in a divided display manner;
receiving a transmission command for the image data or one of the corrected processed image data; and
transmitting the image data or the one corrected processed image data, for which the transmission command was received, to the image server.

4. An image data transmission method for use by a portable terminal apparatus comprising:
a photography means for obtaining image data by photography;
a communication means for transmitting and receiving data;
an image processing means for administering image processes on the image data to obtain processed image data; and
a display means for performing display in various modes; the method comprising the steps of:
receiving an input of an image correction command for the processed image data;
administering image correction processes on the processed image data to obtain corrected processed image data; and
transmitting the image data, along with processing parameters of the image processes and the image correction processes, to an image server for storing and managing the image data.

5. A portable terminal apparatus comprising:
a photography means for obtaining image data by photography;
a communication means for transmitting and receiving data;
an image processing means for administering image processes on the image data to obtain processed image data;
a display means for performing display in various modes;
an image correcting means for receiving input of an image correction command for the processed image data and administering image correction processes to obtain corrected processed image data; and
a control means for transmitting the image data or the corrected processed image data to an image server for storing and managing the image data or the corrected processed image data.

6. A portable terminal apparatus as defined in claim 5, wherein:
the control means displays the image data and the corrected processed image data at the display means in a divided display manner;
receives a transmission command for either the image data or the corrected processed image data; and
transmits either the image data or the corrected processed image data, for which the transmission command was received, to the image server.

7. A portable terminal apparatus as defined in claim 5, wherein:
the control means displays a plurality of corrected processed image data, which has been corrected in a plurality of steps, and the image data on the display means in a divided display manner;
receives a transmission command for the image data or one of the corrected processed image data; and
transmits the image data or the one corrected processed image data, for which the transmission command was received, to the image server.

8. A portable terminal apparatus comprising:
a photography means for obtaining image data by photography;
a communication means for transmitting and receiving data;
an image processing means for administering image processes on the image data to obtain processed image data; and
a display means for performing display in various modes; and
a control means for receiving an input of an image correction command for the processed image data;
administering image correction processes on the processed image data to obtain corrected processed image data; and
transmitting the image data, along with processing parameters of the image processes and the image correction processes, to an image server for storing and managing the image data.

9. A program that causes a computer to execute an image data transmission method for use by a portable terminal apparatus comprising:
a photography means for obtaining image data by photography;
a communication means for transmitting and receiving data;
an image processing means for administering image processes on the image data to obtain processed image data; and
a display means for performing display in various modes; the method comprising the steps of:
receiving an input of an image correction command for the processed image data;
administering image correction processes on the processed image data to obtain corrected processed image data; and
transmitting the image data or the corrected processed image data to an image server for storing and managing the image data or the corrected processed image data.

10. A program that causes a computer to execute an image data transmission method for use by a portable terminal apparatus as defined in claim 9, wherein the method further comprises the steps of:
displaying the image data and the corrected processed image data on the display means in a divided display manner;
receiving a transmission command for either the image data or the corrected processed image data; and
transmitting either the image data or the corrected processed image data, for which the transmission command was received, to the image server.

11. A program that causes a computer to execute an image data transmission method for use by a portable terminal apparatus as defined in claim 9, wherein the method further comprises the steps of:
displaying a plurality of corrected processed image data, which has been corrected in a plurality of steps, and the image data on the display means in a divided display manner;
receiving a transmission command for the image data or one of the corrected processed image data; and
transmitting the image data or the one corrected processed image data, for which the transmission command was received, to the image server.

12. A program that causes a computer to execute an image data transmission method for use by a portable terminal apparatus comprising:
a photography means for obtaining image data by photography;
a communication means for transmitting and receiving data;
an image processing means for administering image sprocesses on the image data to obtain processed image data; and
a display means for performing display in various modes; the method comprising the steps of:
receiving an input of an image correction command for the processed image data;
administering image correction processes on the processed image data to obtain corrected processed image data; and
transmitting the image data, along with processing parameters of the image processes and the image correction processes, to an image server for storing and managing the image data.

13. An image processing method for administering image processes on image data to obtain processed image data, comprising the steps of:
obtaining user data that specifies a user who has requested the image processes;
calculating image processing parameters for the image processes based on the image data;
referring to a database that stores user preferences for each user to read out user preferences corresponding to the user for whom the user data was obtained;
correcting the image processing parameters based on the user preferences to obtain corrected image processing parameters; and
administering the image processes on the image data based on the corrected image processing parameters to obtain the processed image data.

14. An image processing method as defined in claim 13, wherein the user preferences are obtained by:
having a user correct a reference image, on which the image processing is based; and
analyzing the corrected reference image that reflects the preferences of the user.

15. An image processing apparatus for administering image processes on image data to obtain processed image data, comprising:
a user data obtainment means for obtaining user data that specifies a user who has requested the image processes;
a parameter calculation means for calculating image processing parameters for the image processes based on the image data;
a parameter correction means for referring to a database that stores user preferences for each user to read out user preferences corresponding to the user for whom the user data was obtained and correcting the image processing parameters based on the user preferences to obtain corrected image processing parameters; and
an image processing means for administering the image processes on the image data based on the corrected image processing parameters to obtain the processed image data.

16. An image processing apparatus as defined in claim 15, wherein the user preferences are obtained by:
having a user correct a reference image, on which the image processing is based; and
analyzing the corrected reference image that reflects the preferences of the user.

17. A program that causes a computer to execute an image processing method comprising the steps of:
obtaining user data that specifies a user who has requested the image processes;
calculating image processing parameters for the image processes based on the image data;
referring to a database that stores user preferences for each user to read out user preferences corresponding to the user for whom the user data was obtained;
correcting the image processing parameters based on the user preferences to obtain corrected image processing parameters; and
administering the image processes on the image data based on the corrected image processing parameters to obtain the processed image data.

18. A program that causes a computer to execute an image processing method as defined in claim 17, wherein the method further comprises the steps of:
having a user correct a reference image, on which the image processing is based; and
analyzing the corrected reference image that reflects the preferences of the user, thereby obtaining the user preferences.
